(19) United States
(12) Patent Application Publication
(10) Pub. No.: US 2017/0054747 A1
(43) Pub. Date: Feb. 23, 2017

(54) BEHAVIOR DATA MANAGEMENT IN AN APPLICATION COMPONENT ENVIRONMENT

(71) Applicant: defend7, Inc., Mountain View, CA (US)

(72) Inventors: Vibhav Sreekanti, Pleasanton, CA (US); Gaurav Mathur, Palo Alto, CA (US); Richard Spillane, Mountain View, CA (US); Gordon Chaffee, Hillsborough, CA (US)

(21) Appl. No.: 15/229,448

(22) Filed: Aug. 5, 2016

Related U.S. Application Data
(60) Provisional application No. 62/206,505, filed on Aug. 18, 2015.

(51) Int. Cl. H04L 29/06; H04L 12/26; G06F 17/30

(52) U.S. Cl. CPC H04L 63/1425; G06F 17/30719; H04L 43/067

(57) ABSTRACT

Systems, methods, and software provided herein manage behavioral data for application components in a computing environment. In one example, a method of operating collection service includes receiving behavior reports for application containers in a computing environment. Once received, behavioral data in the behavior reports is stored in a tree data structure, wherein the tree data structure includes nodes for various time periods. Once the behavioral data is stored, a request may be generated for a portion of the behavioral data over a defined time period. In response to the request, a response summary may be generated based on the tree data structure and the defined time period.

### RELATED APPLICATIONS

This application claims the benefit of, and priority to, U.S. Provisional Patent Application No. 62/206,505, entitled “BEHAVIOR DATA MANAGEMENT IN AN APPLICATION COMPONENT ENVIRONMENT”, filed Aug. 18, 2015, which is hereby incorporated by reference in its entirety for all purposes.

### TECHNICAL FIELD

Aspects of the disclosure are related to monitoring computing environments and in particular to managing behavior data for application components in a computing environment.

### TECHNICAL BACKGROUND

An increasing number of data security threats exist in the modern computerized society. These threats may include viruses or other malware that attack the local computer of the end user, or sophisticated cyber-attacks to gather data and other information from the cloud or server based infrastructure. This cloud or server based infrastructure includes physical and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

In some examples, an organization may employ a plurality of application or service components, such as front-end components, back-end components, data storage management components, or any other similar component as part of an overarching application. These components may each operate as a physical computing system, or as virtual computing node alongside one or more other components on the same physical host. However, as more components are added to the system, it may become difficult for an administrator to track the behavior of the various components, as well as the host computing systems on which the components may reside.

### OVERVIEW

Provided herein are enhancements of managing operational behavior information for application components of an organization. In one implementation, a method of operating a collection service to manage behavior data for a plurality of application components includes receiving a plurality of behavior reports, wherein the plurality of behavior reports comprise the behavior data for the plurality of application components. The method further includes storing values associated with a behavioral trait of the behavior data in a plurality of nodes for a tree data structure, wherein the plurality of nodes comprises a root node that stores a summary of the values for a full time period and a plurality of child nodes that store partial summaries of the values for segments of the full time period. The method also provides identifying a request to generate a summary of the behavioral trait for a time period, wherein the time period comprises a portion of the full time period, and generating the summary of the behavioral trait based on the time period and the plurality of nodes.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment for reporting operational behavior data to a collection service.

FIG. 2 illustrates a visibility process to manage behavior data for an application component environment.

FIG. 3 illustrates an overview of managing behavior data for application components.

FIG. 4 illustrates an overview of managing behavior data for application components.

FIG. 5 illustrates a user interface capable of displaying a visual representation of behavior data for application components.

FIG. 6 illustrates an overview of reporting behavior data for application components to a collection service.

FIG. 7 illustrates a collection service system capable of collecting and managing behavior data for application components.

### TECHNICAL DISCLOSURE

Internet services rely extensively on security to prevent unpermitted processes and users from accessing sensitive data. Such data may include usernames, passwords, social security numbers, credit card numbers, amongst other sensitive data. To prevent the unpermitted access, firewalls, antiviruses, and other security processes may be executed on the devices hosting the computing services. These security processes are designed to prevent improper access, or mitigate the effects once a breach has occurred.

In some examples, multiple application components may be necessary to provide specific services to end user devices, such as front-end components, back-end components, data service components, administrative components, or any other component. Each of these components are responsible for a particular task, such as taking in and storing data, processing data that is received, organizing data received, or any other task necessary for the service. These application components may be implemented on one or more computing devices and processing systems configured by an administrator to perform the associated service.

In the present example, a plurality of application components may be deployed in a computing environment to provide processes required by an organization. These application components may each comprise a physical computing system, a Linux container, jail, partition, or other type of containment module, a full operating system virtual machine, or some other containment system, including combinations thereof. Here, in addition to the application components, a collection service may be provided, which is accessible to one or more administrators of the computing environment. This collection service communicates with agents associated with the application components to identify behavior data for the components in the environment. This behavior data may include communication data representing information about the data communications for the application components, and processing data that represent information about the execution or processes on each of the application components. In particular, communication data may include the components involved in each communication, the type of communication format used for each communication, the type of security involved in each communication, the amount of data communicated in each communication, the timestamp for each communication, or some other type of communication information. The processing data may include internal operational information about the application components, as well as any host computing systems associated therewith. This operational information may include information about processes executing on the host or application component, information about the packages installed on the host or application component, information about the processes writing to storage media, information about processes reading from storage media, or any other similar processing information.

Once the behavior data is identified, each of the agents communicates the information, as behavior reports, to the collection service. In response to receiving the reports, the collection service stores the data in the reports in one or more data structures, and provides analysis on the reports for the administrators of the computing environment. In the present example, tree data structures may be used to store the behavior data retrieved from the agents in the computing environment. These tree data structures include a root node that stores a summary for a full time period, along with child nodes that store partial summaries of the behavior data for segments of the full time period. In some implementations, a different data structure may be used for each behavioral trait represented in the behavior data. For example, a first data structure may be used to store communication path trait information for data communications in the computing environment, and a second data structure may store trait information about the amount of data transferred in the communications by the application components. Further, any additional data trait may be provided in a separate data structure. In some implementations, rather than storing the behavior data in separate data structures, the data traits may be stored together in a single data structure. Accordingly, as reports are received from the agents, the reports may be summarized into aggregated reports that correspond to summary tree nodes over defined time periods.

Once the behavior data is stored in the data structures, requests may be generated for a summary of at least one trait in the behavior data for a particular time period. In response to a request, the collection service may generate a summary of the at least one trait for the particular time period based on the nodes in the tree data structure. In some implementations, to generate the summary, the collection service may implement a make change algorithm, such as simple dynamic programming or greedy method, or some other similar algorithm to determine the appropriate summary from the summary nodes.

As an illustrative example, behavior data may be collected over an hour period at the collection service, wherein the collection service may include a data structure with a root node for the total hour and six child nodes for ten minute periods that make up the hour. If a request was generated for the first half of the time period, three child nodes that, together, make up the first half of the time period may be used to provide the behavior data necessary for providing a response to the query.

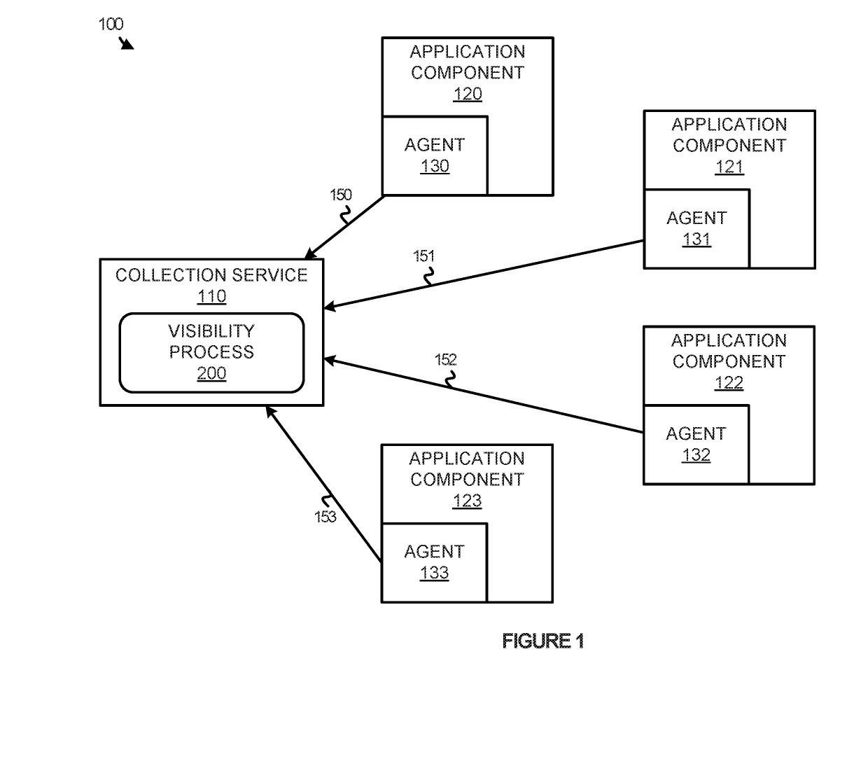

Referring now to FIG. 1, FIG. 1 illustrates a computing environment 100 for reporting communication information to a collection service. Computing environment 100 includes application components 120-123 and collection service 110. Application components 120-123 further include agents 130-133. Collection service 110 is configured to execute visibility process 200. Application components 120-123 communicate with collection service 110 via communication links 150-153.

Application components 120-123 may each comprise a Linux container, jail, partition, or other type of containment module, a full operating system virtual machine, or some other containment system, including combinations thereof. Application components 120-123 may execute via one or more host computing systems that may each include communication interfaces, network interfaces, processing systems, computer systems, microprocessors, storage systems, storage media, or some other processing devices or software systems, and can be distributed among multiple devices. In addition to or in place of the virtual components described above, in some examples, application components 120-123 may each comprise a physical computing system, such as a desktop or server computing system. Associated with application containers 120-123, agents 130-133 may comprise one or more software processes that monitor behavior data for the application components and any associated host computing systems for the application components.

Collection service 110 may comprise a physical computing system, such as a desktop or serving computing system, and may also comprise a virtual node, such as a virtual machine or container, that executes via a host computing system. Collection service 110 may comprise communication interfaces, network interfaces, processing systems, computer systems, microprocessors, storage systems, storage media, or some other processing devices or software systems, and can be distributed among multiple devices.

Application components 120-123 communicate with collection service 110 via a plurality of communication links 150-153. These communication links may each use metal, glass, optical, air, space, or some other material as the transport media. Communication links 150-153 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 150-153 may each be a direct link, or may include intermediate networks, systems, or devices, and may include a logical network link transported over multiple physical links.

In operation, application components 120-123 provide particular operations within a computing network. These operations may include front-end service operations, back-end service operations, database operations, data backup operations, or any other similar operation. To monitor the behavior of the application components of computing environment 100, collection service 110 is provided to maintain the operational behavior data for the plurality of application components 120-123. In particular, the behavior data may include communication information, such as data flow information representing the devices or application components involved in each communication, the type of data included in each communication, the type of communication format used in the communication, such as Hypertext Transfer Protocol (HTTP) or secure sockets layer (SSL), the amount of data communicated, the type of security used in the communication, amongst a variety of other communication information. In addition to or in place of the communication data, the behavior data may include processing data related to internal operational information about the application components, as well as any host computing systems associated therewith. This operational information may include information about processes executing on the host or application component, information about the packages installed on the host or application component, information about the processes writing to storage media, information about processes accessing storage, or any other similar processing information.

As the information is collected by agents 130-133, agents 130-133 may transfer information as behavior reports to collection service 110. These behavior reports may be transferred at discretion of the agents, may be transferred periodically, such as every fifteen minutes or some other periodic time frame, may be transferred upon request of collection service 110, or may be transferred at any other interval during the operation of the computing environment. As reports are transferred from agents associated with the application components, collection service 110 may execute visibility process 200 to organize the reports into one or more data structures to assist in providing feedback about the current operational status of the computing environment.

Although illustrated as located within the application components, it should be understood that agents 130-133 might reside on host computing systems providing the platform for application components 120-123. For example, if an application component comprises a virtual machine, the agent may operate within the kernel of the host system to determine the communication interactions for the application container. Thus, rather than having a single agent per application component, it should be understood that a single agent on a host computing system may manage the communication connections for a plurality of application components executing on the host.

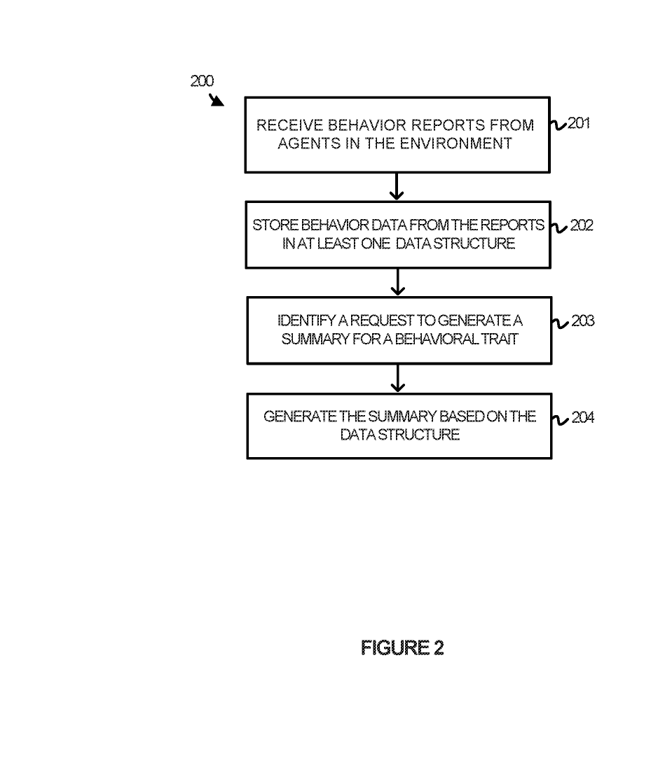

To further demonstrate the operation of collection service 110, FIG. 2 is provided. FIG. 2 illustrates a visibility process 200 to manage behavior data for an application component environment. As described in FIG. 1, a computing environment may employ a plurality of application components, each configured to accomplish a particular task. For example, a first application component may comprise a front-end service, while a second application component may comprise a back-end service. To maintain information about the operational behavior the application components, application components 120-123 are associated with agents 130-133, which are processes configured to collect operational behavior data for the components and provide the data to collection service 110. Agents 130-133 may reside within the kernel of host computing systems supporting application components 120-123, may reside as a process within application components 120-123, or may reside in any other location capable of identifying behavior data and transferring the data as a behavior report to collection service 110.

Visibility process 200 on collection service 110 includes receiving the behavior reports from the agents within computing environment 100 (201). Once received, visibility process 200 stores behavior data from the reports in at least one data structure (202), wherein the data structures comprise tree data structures with a root node and a plurality of child nodes. In particular, the reports provided by the agents include data about various behavior traits, including communication traits and processing traits for the application components. These application traits are then stored in the nodes of the data trees based on a time stamps associated with the data in the reports. The root node stores a summary of trait values for a full time period, and the plurality of child nodes store partial summaries of trait values for segments of the full time period.

For example, reports from agents 130-133 may provide data about a communication path trait, or which application components are in communication with other application components. As the reports are received, values associated with the communication path trait are stored in the data structure based on the time period with which they were retrieved. For example, if a full time period of operation of computing environment 100 were a day, the root node may summarize values associated with the communication path trait over the full twenty-four hours. Whereas the child nodes may summarize segments of the twenty-four hours. For instance, a first level of child nodes may summarize values or communication interactions for the communication trait over twelve hour increments, and second level of child nodes may summarize values for the communication trait over individual hour increments. Based on time stamps associated with the behavior reports, values from the reports may be added to the data structure to summarize the operation of the computing network.

As the data is stored within the one or more data structures, visibility process 200 identifies a request to generate a summary for a behavioral trait that is stored in the data structures over a time period (203). This request may be generated by an administrator of the computing environment, by an automated process configured to generate a summary request, or by any other similar source. Once the request is identified, visibility processes 200 generates the summary based on the data structures and the time period defined in the request (204). As described previously, data values associated with various behavioral traits may be stored within a data structure to summarize the operation of the computing environment. Once a request is generated for a particular time period, collection service 110 may identify one or more of the nodes within the data structure that can be combined to provide a summary of the particular time period. Accordingly, rather than combining each individual report at the time of the query, partial summaries may be combined to provide the requested summary. In some implementations, a make change algorithm may be applied with the data structure to generate the summary over the desired time period. However, it should be understood that any other algorithm may be applied to combine the nodes of the data structure.

In some examples, the summaries provided in the data structure may not provide an exact summary of a behavioral trait over the desired time period. Accordingly, collection service 110 may provide an estimated summary over the desired time period based on the nodes, or may, at the time of inquiry, summarize a portion of reports that compensate for time periods not already summarized by the nodes. For example, if the nodes summarized hour time periods, but the request was for a half hour time period, reports for the half hour time period may be used to provide the response to the request.

Although illustrated in the example of FIG. 1 as including four application components, it should be understood that any number of application components might be included within a communication environment. Further, in some implementations, the individual application components may be clustered as service groups. Accordingly, if a computing environment included three front-end application components, the components may be referred to as a front-end service group, and behavior data may be aggregated for the service group to provide operational feedback to an administrator or other requesting process.

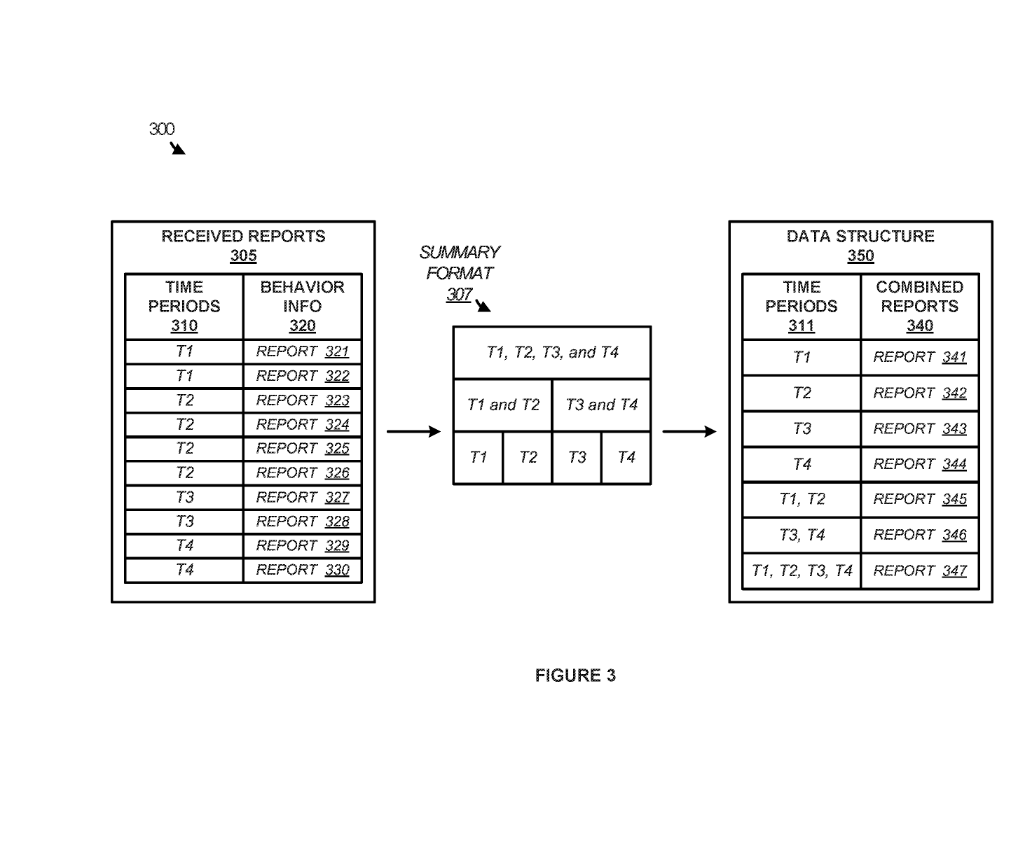

To further demonstrate the generation of data structures to summarize behavior reports, FIG. 3 is provided. FIG. 3 illustrates an overview 300 of managing behavior data for application components. Overview 300 includes received reports 305, summary format 307, and data structure 350. As described herein, a collection service receives a plurality of behavior reports from agents corresponding to application components in a computing environment. As the behavior reports are received, the collection service may process the reports to store data values from the reports into tree data structures. These data values may include information about the communication traits of the application components, as well as processing traits for the application components and any associated host computing systems.

As illustrated in FIG. 3, received reports 305, which correspond to reports transferred from agents in the computing environment, includes time periods 310 and behavior information 320. Time periods 310 correspond to time periods that are used in summarizing the reports from the various application components, and behavior information corresponds to information provided in the individual reports 321-330. As the reports are received, the collection service initiates an action to place the reports in summary format 307. Summary format 307 comprises a tree structure that can be used to summarize reports and the behavior data as it is retrieved from the agents of the environment. In particular, overview 300 includes four time periods T1, T2, T3, and T4, which are the smallest time periods for the child nodes. Overview 300 also includes secondary child nodes that summarize the T1 and T2 time periods, and the T3 and T4 time periods, and also includes a root node that summarizes all of the time periods.

Based on the summary format 307, data structure 350 may be generated with time periods 311 and combined reports 340. Combined reports 340 include reports 341-347, which are used to represent summarized behavior data for reports received during the time periods. For example report 341 may represent data for reports 321 and 322 from received reports 305. In some implementations, a collections service may maintain a single data structure that can be used to summarize all of the information received in the reports. However, in other implementations, it should be understood that multiple data structures may be generated that correspond to one or more particular traits. For instance, a first data structure may be used to manage the communication interaction or path information for the computing environment, whereas a second data structure may be used to manage information about the processes executing on each application component.

Once the data is stored within data structure 350, the collection service may receive a query regarding a particular trait over a defined time period. Based on the defined time period, a summary may be generated using the data structure generated from the received reports. For example, if an administrator requested information about a particular communication or processing trait over time periods T1, T2, and T3, reports 345 and 343 may be combined to provide the desired information. Accordingly, rather than combining information from reports 321-328, two reports may be combined to provide the desired information.

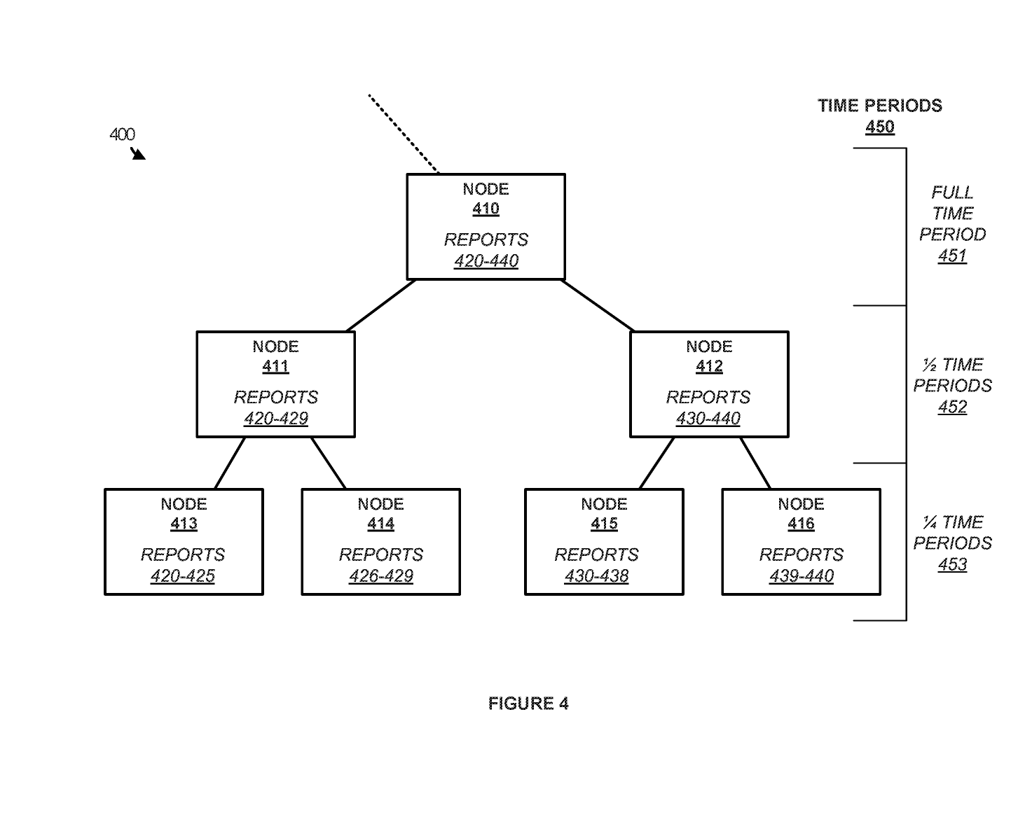

Turning to FIG. 4, FIG. 4 illustrates an overview 400 of managing behavior data for application components. Overview 400 represents a data structure format for managing behavior data received from agents in an application component environment. The behavior data may include various information about communication traits and processing traits within the application component environment. The communication traits may include communication path or interaction traits, quantity of data transferred traits, the type of communication format traits, or any other similar communication trait. The processing traits may correspond to operational traits of the application components and any associated host computing systems for the application components. These traits may include processes executing on the application components or host computing systems, packages installed on the applications or host computing systems, information about which application components are writing to or accessing storage media, or any other similar operational trait. Overview 400 includes a data tree structure made of nodes 410-416 and time periods 450. Nodes 410-416 are used to summarize the information provided in reports 420-440, and time periods 450 are divided into full time period 451, half time periods 452, and quarter time periods 453. Although illustrated with seven nodes in the present example, it should be understood that a data structure may use any number of nodes to summarize data over a period of time. Further, it should be understood that the data structure represented in FIG. 4 may be representative of a portion of a larger data structure, as demonstrated by the open connector from node 410.

In operation, a collection service receives reports corresponding to behavior data for application components in a computing environment. As the reports are received, the data from the reports is summarized and stored in nodes of a tree data structure based on time stamps associated with the data. For example, reports 420-425 are associated with time stamps that qualify the reports to be summarized in node 413, node 411, and node 410. In contrast, reports 439-440 qualify to be summarized in node 416, node 412, and node 410. As illustrated, the different levels of the tree data structure are configured to be summarized behavior data for various time periods. Accordingly, when a request is generated for a particular portion of time, rather than summarizing each of the reports individually, the pre-generated report summaries in the data tree may be used. For example, if a request is generated for information for a behavioral trait in the first three quarters of full time period 451, the collection service may generate a summary based on nodes 411 and 415. This generation of the summary may include adding values to generate a summary, identifying a list of values that are present within the nodes, or any other similar action to generate a desired summary. For example, data packet totals reported in each report may be summed to generate the summaries of nodes 410-416. In another example, communication interactions reported from the agents may be summarized to generate the summaries of nodes 410-416. Accordingly, even if two reports within the same time period included the same communication interaction, only a single record of the interaction may be required for node summary.

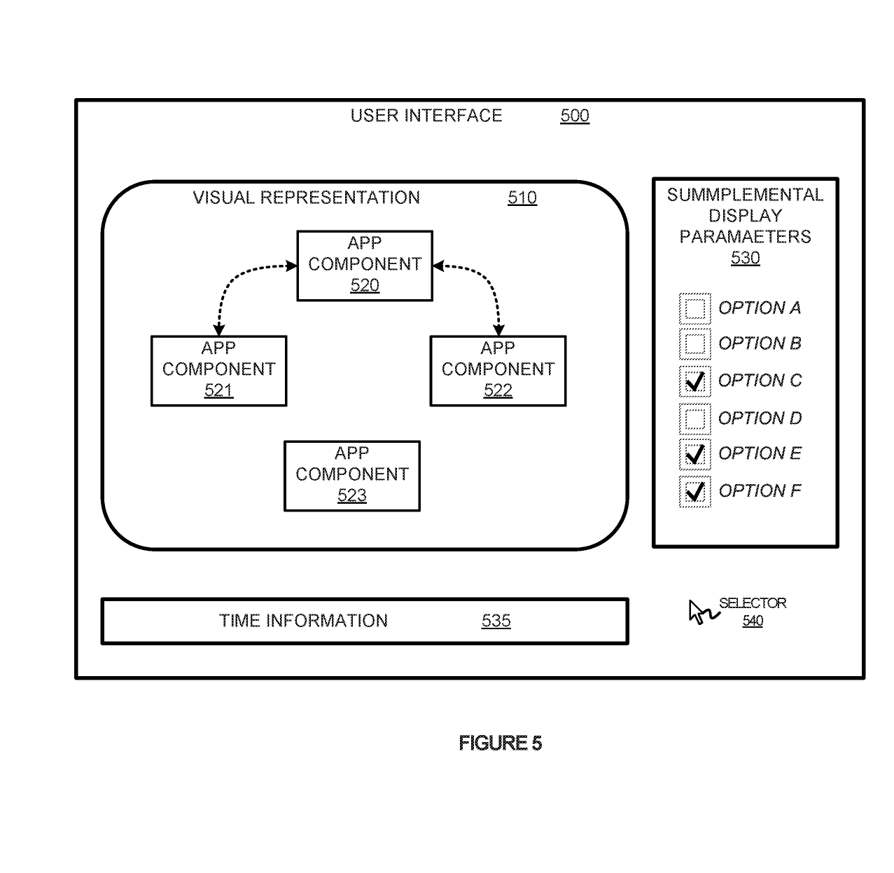

Referring to FIG. 5, FIG. 5 illustrates a user interface 500 capable of displaying a visual representation of behavior data for application components. User interface 500 includes visual representation 510, supplemental display parameters 530, time information 535, and selector 540. User interface 500 is an example interface that may be provided to an administrator by a collection service allowing the administrator to generate requests and receive responses to queries about the operational status of the application component environment. It should be understood that user interface 500 is just one example of providing a summary of the computing environment, other visual representations of the operational status may include lists, feeds, or any other similar information about the status of the environment.

As described herein, reports with behavior information for an application component environment are received by a collection service to assist administrators in identifying the operational behavior of the environment. These reports may include data about various traits of the individual components including communication traits, such as which components and how much data is being communicated, as well as processing traits related to the packages installed and executing on the application components and any associated host computing systems. As the reports are retrieved, data values corresponding to the traits are stored and summarized within one or more data structures that can be queried to respond for a particular period of time requested by the administrator at user interface 500.

In the present example, user interface 500 includes supplemental display parameters 530 and time information 535, which can be used by the administrator to define what information is provided in visual representation 510. Supplemental display parameters 530 includes options of traits selectable by an administrator to be viewed in visual representation 510. These traits may include communication traits for application components 520-523, processing traits for application components 520-523, or any other similar behavior trait related to the application components. For example, the administrator may select to view communication interaction information for the application components, as well as information about the total number of packets transferred between the various components. In addition to identifying the traits in supplemental display parameters 530, time information 535 may be used to identify a time period relevant to the administrator. Time information 535 may include a slider input for a relevant time period, a data entry box for a relevant time period, or any other user input for the relevant time period.

Once the information is provided in supplemental display parameters 530 and time information 535, the collection service may generate a summary, which can be displayed via visual representation 510. Here, visual representation 510 displays communication interactions between application components 520-522. Although illustrated with just the communication interactions, it should be understood that other information may be provided in visual representation 510. This information may include text summarizing the behavior of the environment in the desired time period, noises or sounds relaying information for the desired time period, or any other similar type of user interaction.

In some implementations, rather than providing each of the application components individually, the application components may be arranged as a service group. For example, all of the application components that provide a front-end service may be arranged in a front-end service group, while all of the application components that provide the back-end service may be arranged in a back-end service group. Accordingly, when generating the summaries, either in the data structures or upon a summary request, service group behavioral data may be provided to the administrator. For example, rather than treating each of the application components separately, the communication interactions for a service group may be provided as if the service group is a single component.

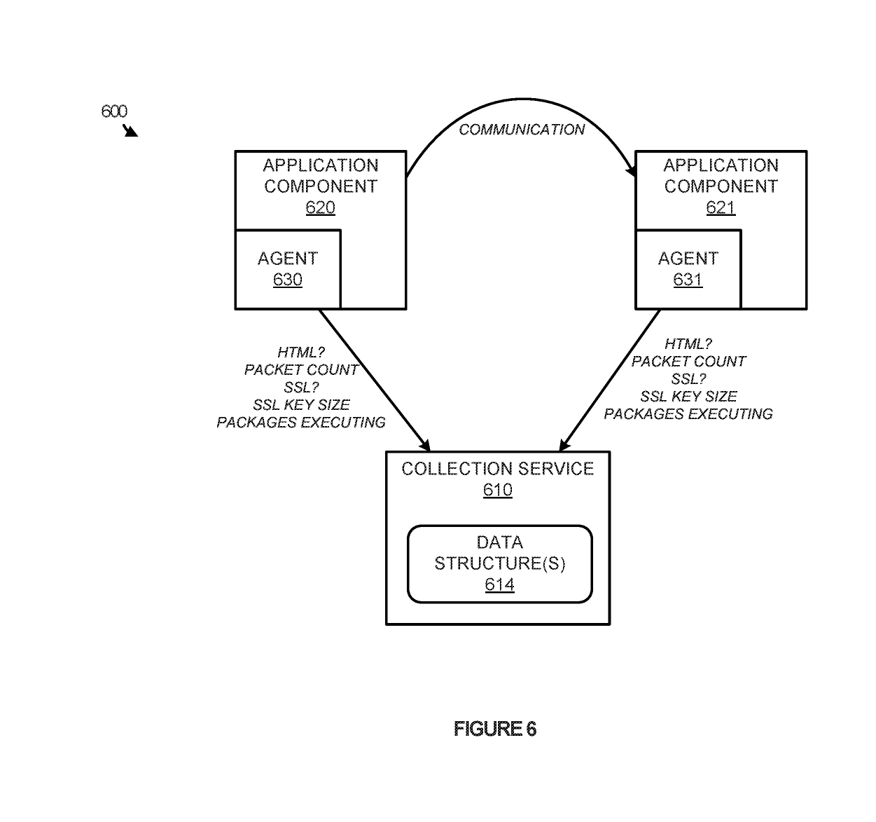

FIG. 6 illustrates an overview 600 of reporting behavior data for application components to a collection service. Overview 600 includes collection service 610 and application components 620-621, which are associated with agents 630-631. Collection service 610 further includes data structures 614 that are used to store behavior data for application components in a computing environment.

In operation, application components provide various operations in a computing environment including, but not limited to, front-end component services, back-end component services, database services, or any other similar service for a computing environment. During the operation of the application components, agents 630-631, which are processes associated with the application components monitor behavior data for the components and report the data back to collection service 610. This behavior data may include data about various communication and processing traits for the application components including the communication path or containers involved in communications, the type of communication format (Hypertext Markup Language or HTML, MYSQL, etc.) used in communications, the amount of data transferred in communications, the SSL configuration of the communications, including the SSL key size, the types of packages executing and available on the applications, amongst other possible traits. In some implementations, the agents may be located within the application components configured to operate in the background and determine the behavior of each of the components. In other implementations, the agents may reside wholly or partially on host computing systems for the application components, and may further monitor information about the packages installed or being executed on the host, as well as what packages or processes are writing and reading from storage media.

Once the behavior data is determined by the agent monitoring processes, the data is transferred as behavior reports to collection service 610. Collection service 610 receives the reports, and initiates storage of the reports in data structures 614. In the present example, data structures 614 include at least one tree data structure that can be used to summarize and store behavior data from the reports. This tree data structure allows a plurality of nodes to summarize, for varying time periods, behaviors of the application component environment. In particular, a first root node may be used to summarize the operation of the environment for a full time period, and supplementary child nodes may be used to summarize the operation of the environment for segments of the full time period.

Referring to the example in FIG. 6, a data structure may be maintained that includes trait information about the number of packets transferred between application component 620 and application component 621. This data structure includes a root node that provides a total number of packets transferred over the full time period. In addition, the data structure includes a plurality of child nodes that maintain information about the total number of packets transferred over segments of the full time period. Accordingly, if four reports with data packet totals were received in a particular time period, the packet totals may be summed to produce the appropriate node of the data structure. As the information is maintained in the data structure, queries may be made to the data structure to generate a summary of a particular trait based on the summaries. Rather than summarizing the individual reports at the time of the inquiry, one or more nodes may be used to summarize the necessary trait. This summary using the data structure may be accomplished using a make change algorithm, such as simple dynamic programming, linear programming, or a greedy method algorithm, or any other method of selecting nodes to produce the summary.

In some implementations, the summary provided by collection service 610 to a request may comprise an estimated summary. For example, if an administrator selected a time frame that could not accurately be summarized using the nodes of the data structure, the data structure may provide a summary response that most accurately reflects the information requested. In other implementations, collection service 610 may provide a precise summary to the request by supplementing information in the data structure with data from individual reports. For example, three nodes may be used to summarize a majority of a particular time period, however, one or more individual reports may be required to summarize the remaining portions of the time period.

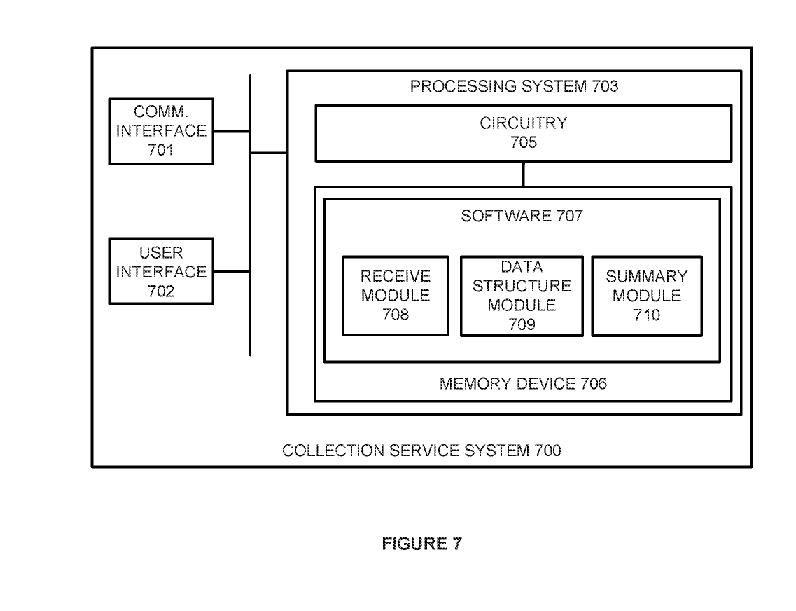

FIG. 7 illustrates a collection service system 700 capable of collecting and managing behavior data for application components. Collection service system 700 is representative of any computing system or systems with which the various operational architectures, processes, scenarios, and sequences disclosed herein for a collection service may be implemented. Collection service system 700 is an example of collection service 110 and collections service 610, although other examples may exist. Collection service system 700 comprises communication interface 701, user interface 702, and processing system 703. Processing system 703 is linked to communication interface 701 and user interface 702. Processing system 703 includes processing circuitry 705 and memory device 706 that stores operating software 707. Collection service system 700 may include other well-known components such as a battery and enclosure that are not shown for clarity. Collection service system 700 may comprise one or more server computing systems, desktop computing systems, laptop computing systems, or any other computing system, including combinations thereof.

Communication interface 701 comprises components that communicate over communication links, such as network cards, ports, radio frequency (RF), processing circuitry and software, or some other communication devices. Communication interface 701 may be configured to communicate over metallic, wireless, or optical links Communication interface 701 may be configured to use Time Division Multiplex (TDM), Internet Protocol (IP), Ethernet, optical networking, wireless protocols, communication signaling, or some other communication format—including combinations thereof. In particular, communication interface 701 communicates with computing systems that provide an application component environment. These computing systems include one or more agents that retrieve behavioral data for the application components of the environment.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples.

Processing circuitry 705 comprises microprocessor and other circuitry that retrieves and executes operating software 707 from memory device 706. Memory device 706 comprises a non-transitory storage medium, such as a disk drive, flash drive, data storage circuitry, or some other memory apparatus. Processing circuitry 705 is typically mounted on a circuit board that may also hold memory device 706 and portions of communication interface 701 and user interface 702. Operating software 707 comprises computer programs, firmware, or some other form of machine-readable processing instructions. Operating software 707 includes receive module 708, data structure module 709, and summary module 710, although any number of software modules may provide the same operation. Operating software 707 may further include an operating system, utilities, drivers, network interfaces, applications, or some other type of software. When executed by processing circuitry 705, operating software 707 directs processing system 703 to operate collections service system 700 as described herein.

In particular, receive module 708 directs processing system 703 to, via communication interface 701, obtain behavior reports from agents in an application component environment. These agents, which operate as monitoring processes in the application components and/or the associated host computing systems, gather behavior data for various operational traits of the application component systems. Such traits may include communication path information for each communication, information about the number of packets transferred in each communication, information about the security or communication format used in each communication, or any other similar communication information. Further, in addition to or in place of the communication information, the traits may also include processing traits, such as the packages executing on each application container or host, packages installed on each application container or host, processes writing to and reading from storage media, or other similar processing information. As the behavior data is gathered by the agents, the agents may transfer reports to collection service system 700 with the behavior data. This transfer may occur periodically, by request of collection service system 700, or at any other similar instance.

In response to receiving the reports from the agents, data structure module 709 directs processing system 703 to store the data from the reports into one or more data structures. These data structures are used to summarize the data in the reports over defined time periods. In particular, the received behavior data may include values for the various traits monitored by the agents in the environment. These values may include a quantity of packets transferred in a communication, identifiers for the application components involved in a communication, identifiers for packages installed on a component or host, or any other similar value associated with traits monitored by the agents of the environment. As the values are received, the values may be summarized in nodes of a tree data structure based on a time stamp associated with the identification of the value. For example, three reports may be provided in a time period that disclose the processes executing a particular host computing system in the application component environment. These reports may then be combined into a single report that provides information on the processes executing on the host computing system during the time period. Thus, even if one application was executing in one report, but not in another report, it would still be included in the summary node for the time period.

As the behavior data is stored in the one or more data structures, summary module 710 directs processing system 703 to identify a request to generate a summary for a trait based on the one or more data structures. This request may be provided by an administrator of the application component environment, may be generated by an automated process, or may be generated by any other means. In response to the request, summary module 710 directs processing system 703 to generate a summary based on the data structures and the request time period. In some implementations, collection service system 700 may employ a make change algorithm to generate the summary, however, it should be understood that any other similar algorithm may be used to determine the appropriate node or nodes that should be used in generating the summary.

In some implementations, generating the summary may include generating a display of the requested information for an administrator. This display may include a visual representation of the application components or service groups along with the requested information. However, the display may also comprise a textual representation such as a feed or some other view of the requested information.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a collection service to manage behavior data for a plurality of application components, the method comprising:
receiving a plurality of behavior reports, wherein the plurality of behavior reports comprise the behavior data for the plurality of application components;
storing values associated with a behavioral trait of the behavior data in a plurality of nodes for a tree data structure, wherein the plurality of nodes comprises a root node that stores a summary of the values for a full time period and a plurality of child nodes that store partial summaries of the values for segments of the full time period;
identifying a request to generate a summary of the behavioral trait for a time period, wherein the time period comprises a portion of the full time period; and
generating the summary of the behavioral trait based on the time period and the plurality of nodes.

2. The method of claim 1 wherein the behavioral data comprises communication data and processing data for the plurality of application components.

3. The method of claim 2 wherein the behavioral trait comprises one of a communication trait or a processing trait for the plurality of application components.

4. The method of claim 3 wherein the communication trait comprises a communication path trait, a communication protocol trait, or a packet transfer quantity trait.

5. The method of claim 3 wherein the behavioral data for the plurality of application components, comprises behavioral data for the plurality of application components and host computing systems associated with the plurality of application components.

6. The method of claim 5 wherein the processing trait comprises one of an executing processes trait, a packages installed trait, or a processes writing to storage media trait.

7. The method of claim 1 wherein generating the summary of the behavioral trait based on the time period and the plurality of nodes comprises generating, using a make change algorithm, the summary of the behavioral trait based on the time period and the plurality of nodes.

8. The method of claim 1 wherein identifying the request to generate the summary of the behavioral trait for the time period comprises identifying an administrator request to generate the summary of the behavioral trait for the time period.

9. The method of claim 1 further comprising generating a display of the summary of the behavioral trait.

10. The method of claim 1 wherein receiving the plurality of behavior reports comprises receiving, from agents associated with the application components, the plurality of behavior reports.

11. An apparatus to manage behavior data for a plurality of application components, the apparatus comprising:
one or more non-transitory computer readable media; and
processing instructions stored on the one or more non-transitory computer readable media that, when executed by a processing system, direct the processing system to:
receive a plurality of behavior reports, wherein the plurality of behavior reports comprise the behavior data for the plurality of application components;
store values associated with a behavioral trait of the behavior data in a plurality of nodes for a tree data structure, wherein the plurality of nodes comprises a root node that stores a summary of the values for a full time period and a plurality of child nodes that store partial summaries of the values for segments of the full time period;
identify a request to generate a summary of the behavioral trait for a time period, wherein the time period comprises a portion of the full time period; and
generate the summary of the behavioral trait based on the time period and the plurality of nodes.

12. The apparatus of claim 11 wherein the processing system configured to generate the summary of the behavioral trait based on the time period and the plurality of nodes direct the processing system to generate, using a make change algorithm, the summary of the behavioral trait based on the time period and the plurality of nodes.

13. The apparatus of claim 11 wherein the processing instructions to identify the request to generate the summary of the behavioral trait for the time period direct the processing system to identify an administrator request to generate the summary of the behavioral trait for the time period.

14. The apparatus of claim 11 wherein the processing instructions further direct the processing system to generate a display of the summary of the behavioral trait.

15. The apparatus of claim 11 wherein the behavioral data comprises communication data and processing data for the plurality of application components, and wherein the behavioral trait comprises one of a communication trait or a processing trait for the plurality of application components.

16. The apparatus of claim 11 wherein the communication trait comprises a communication path trait, a communication protocol trait, or a communication data quantity trait.

17. A system to manage behavior data for a plurality of application components, the system comprising:
a plurality of agents configured to:
identify behavior data for the plurality of application components; and
transfer the behavior data as behavior reports to a collections service; and
the collection service configured to:
receive the behavior reports;
store values associated with a behavioral trait of the behavior data in a plurality of nodes for a tree data structure, wherein the plurality of nodes comprises a root node that stores a summary of the values for a full time period and a plurality of child nodes that store partial summaries of the values for segments of the full time period;
identify a request to generate a summary of the behavioral trait for a time period, wherein the time period comprises a portion of the full time period; and
generate the summary of the behavioral trait based on the time period and the plurality of nodes.

18. The system of claim 17 wherein the collection service system is further configured to generate a display of the summary of the behavioral trait.

19. The system of claim 17 wherein the processing system configured to generate the summary of the behavioral trait based on the time period and the plurality of nodes direct the processing system to generate, using a make change algorithm, the summary of the behavioral trait based on the time period and the plurality of nodes.

20. The system of claim 17 wherein the behavioral data comprises communication data and processing data for the plurality of application components, and wherein the behavioral trait comprises one of a communication trait or a processing trait for the plurality of application components.
